(19) United States
(12) Patent Application Publication
(10) Pub. No.: US 2018/0285778 A1
(43) Pub. Date: Oct. 4, 2018

(54) SENSOR DATA PROCESSOR WITH UPDATE ABILITY

(71) Applicant: Microsoft Technology Licensing, LLC, Redmond, WA (US)

(72) Inventors: Aditya Vithal NORI, Cambridge (GB); Antonio CRIMINISI, Cambridge (GB); Siddharth ANCHA, Toronto (CA); Loïc LE FOLGOC, Cambridge (GB)

(21) Appl. No.: 15/628,564

(22) Filed: Jun. 20, 2017

(30) Foreign Application Priority Data
Mar. 31, 2017 (GB) 1705189.7

(51) Int. Cl. G06N 99/00; G06N 5/04; G06N 7/00

(52) U.S. Cl. CPC G06N 99/005; G06F 17/18; G06N 7/005; G06N 5/043

(57) ABSTRACT

A sensor data processor is described comprising a memory storing a plurality of trained expert models. The machine learning system has a processor configured to receive an unseen sensor data example and, for each trained expert model, compute a prediction from the unseen sensor data example using the trained expert model. The processor is configured to aggregate the predictions to form an aggregated prediction, receive feedback about the aggregated prediction and update, for each trained expert, a weight associated with that trained expert, using the received feedback. The processor is configured to compute a second aggregated prediction by computing an aggregation of the predictions which takes into account the weights.

### CROSS-REFERENCE TO RELATED APPLICATIONS

This application claims priority to GB application serial number 1705189.7, filed Mar. 31, 2017, the entirety of which is hereby incorporated by reference herein.

### BACKGROUND

Sensor data such as medical image volumes, depth images, audio signals, videos, accelerometer signals, digital photographs and signals from other types of sensors is low level detailed data from which patterns need to be extracted for a variety of different tasks, such as body organ detection, body joint position detection, speech recognition, surveillance, position or orientation tracking, semantic object recognition and others. Existing approaches to extracting patterns from low level sensor data include the use of sensor data processors such as machine learning systems which compute predictions from the sensor data such as predicted image class labels or predicted regressed values such as predicted joint positions. Various types of machine learning system are known including neural networks, support vector machines, random decision forests and others.

Machine learning systems are often trained in an offline training stage using large quantities of labeled training examples. Offline training means updates to a machine learning system in the light of evidence, which are made at a time when the machine learning system is not being used for a purpose other than training. The offline training may be time consuming and is therefore typically carried out separately to use of the machine learning system at so called “test time” where the machine learning system is used for the particular task that it has been trained on. Online training of machine learning systems is not workable for many application domains because at test time, when the machine learning system is being used for speech recognition or other tasks in real time, there is insufficient time to carry out training. Online training refers to training which occurs together with or as a part of test time operation of a machine learning system.

The embodiments described below are not limited to implementations which solve any or all of the disadvantages of known machine learning systems or image processing systems.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A sensor data processor is described comprising a memory storing a plurality of trained expert models. The machine learning system has a processor configured to receive an unseen sensor data example and, for each trained expert model, compute a prediction from the unseen sensor data example using the trained expert model. The processor is configured to aggregate the predictions to form an aggregated prediction, receive feedback about the aggregated prediction and update, for each trained expert, a weight associated with that trained expert, using the received feedback. The processor is configured to compute a second aggregated prediction by computing an aggregation of the predictions which takes into account the weights.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a sensor data processor comprising a plurality of trained expert models, and with update ability;

FIG. 2A is a schematic diagram of a slice of a medical image volume showing a predicted brain tumour and feedback;

FIG. 2B is a schematic diagram of another slice of the same medical image volume showing the brain tumour;

FIG. 2C is a schematic diagram of the slice of the medical image volume from FIG. 2A and a second prediction of the brain tumour after update using the feedback;

FIG. 2D is a schematic diagram of the slice of the medical image volume from FIG. 2B and showing the second prediction of the brain tumour;

FIG. 3 is a schematic diagram of the trained expert models of the sensor data processor in more detail;

FIG. 3A is a schematic diagram of a graphical model of the trained expert models;

FIG. 3B is a schematic diagram of the graphical model of FIG. 3A conditioned on feedback labels;

FIG. 3C is a flow diagram of a method of region growing;

FIG. 4 is a flow diagram of a method of operating a trained random decision forest at test time;

FIG. 5 is a flow diagram of a method of training a random decision forest;

FIG. 6 is illustrates an exemplary computing-based device in which embodiments of a sensor data processor are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

In various sensor data processing applications trained predictors are used to compute predictions such as image labels, speech signal labels, body joint positions and others. The quality of the predictions varies as the nature of trained predictors means that the ability of the predictor to generalize to examples which are dissimilar to those on which it was trained may be poor. In various scenarios, feedback about the quality of one or more of the predictions becomes available during operation of the sensor data processor. However, it is difficult to immediately make use of the feedback because typically, online training is not practical at the working time scales involved. In this case, feedback instances are collected in a store and used later in an offline training stage. After the offline training the sensor data processor is updated by replacing the predictors with those which have been trained in the most recent offline training. The new predictors are then used going forward to compute new predictions from sensor data examples which are received and the accuracy is typically improved since the offline training has been done.

Another approach is to collect the feedback and use it to update or correct individual predictions themselves rather than to update the predictor(s). This approach is more practical to implement as an online process since there is no time consuming update to the predictors. However, as there is no change to the predictors, the performance of the predictors going forward does not improve.

Various examples described herein explain how online training of a predictor is achieved in real time in an effective and efficient manner. This enables feedback to be taken into account immediately and used to correct predictions which have already been made. In addition, the predictor itself is updated using the feedback so that performance going forward is improved in terms of accuracy.

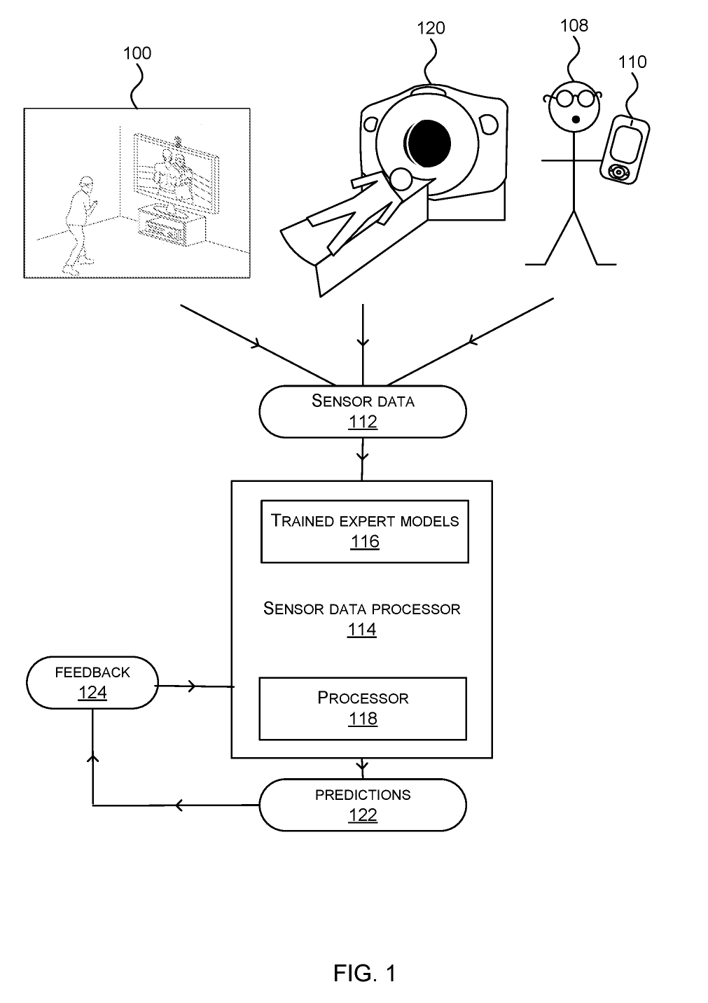

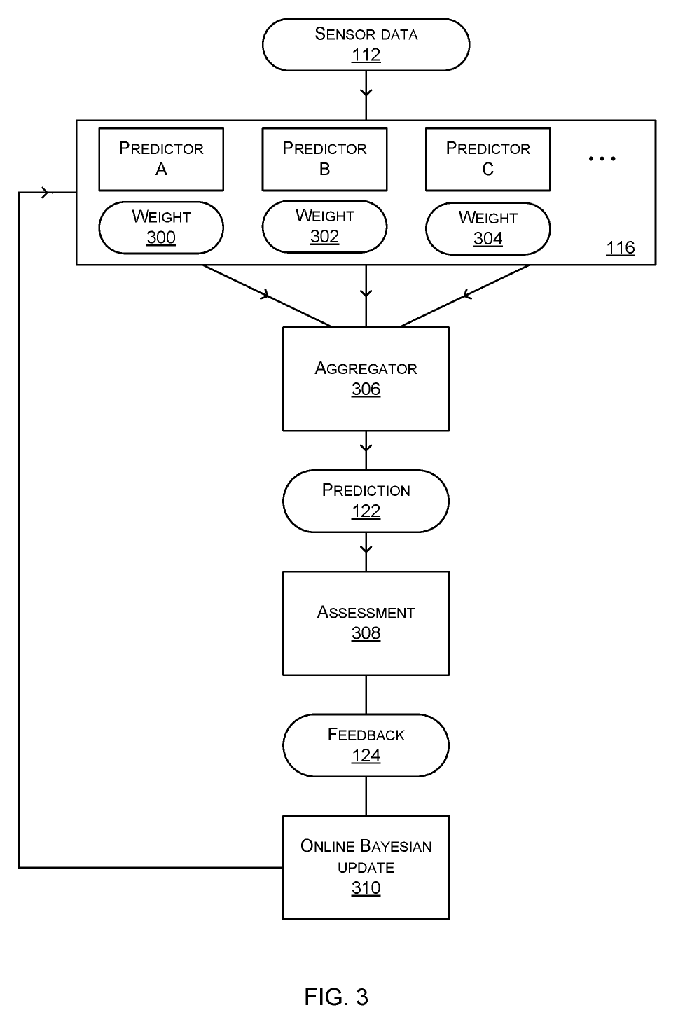

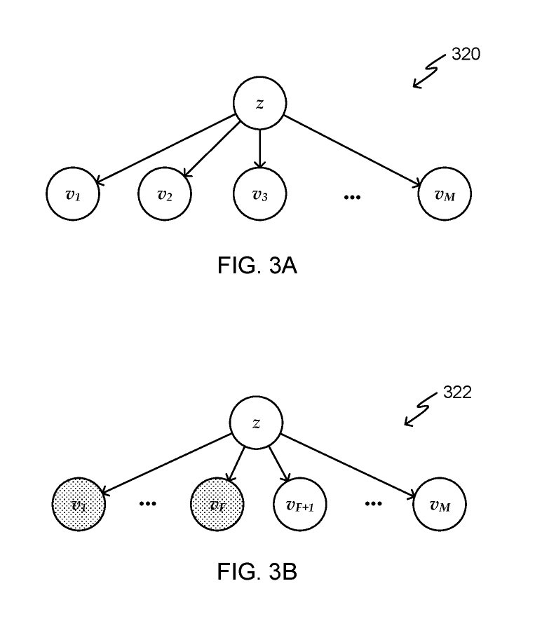

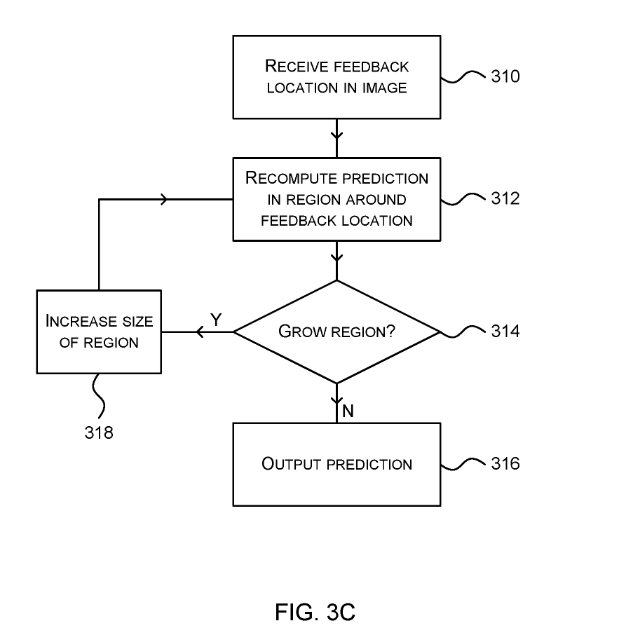

FIG. 1 is a schematic diagram of a computer-implemented sensor data processor 114 comprising a plurality of trained expert models 116, and where the sensor data processor 114 has the ability to update itself using feedback 124 as described in more detail below. A trained expert model is a predictor such as a neural network, support vector machine, classifier, random decision tree, directed acyclic graph, or other predictor as explained below with reference to FIG. 3. Sensor data 112 comprises measurement values from one or more sensors. A non-exhaustive list of examples of sensor data is: depth images, medical image volumes, audio signals, videos, digital images, light sensor data, accelerometer data, pressure sensor data, capacitive sensor data, silhouette images and others.

For example, FIG. 1 shows a scenario 100 with a depth camera which is part of game equipment in a living room capturing depth images of a game player; in this scenario the sensor data 112 comprises depth images and the sensor data processor 114 is trained to predict body joint positions of the game player which are used to control the game. For example, FIG. 1 shows a scenario 120 with a magnetic resonance imaging (MRI) scanner; in this scenario the sensor data 112 comprises MRI images and the sensor data processor 114 is trained to predict class labels of voxels of the MRI images which label the voxels as depicting various body organs or tumours. For example, FIG. 1 shows a scenario with a person 108 speaking into a microphone of a smart phone 110; in this case the sensor data 112 comprises an audio signal and the sensor data processor 114 is trained to classify the audio signal values into phonemes or other parts of speech.

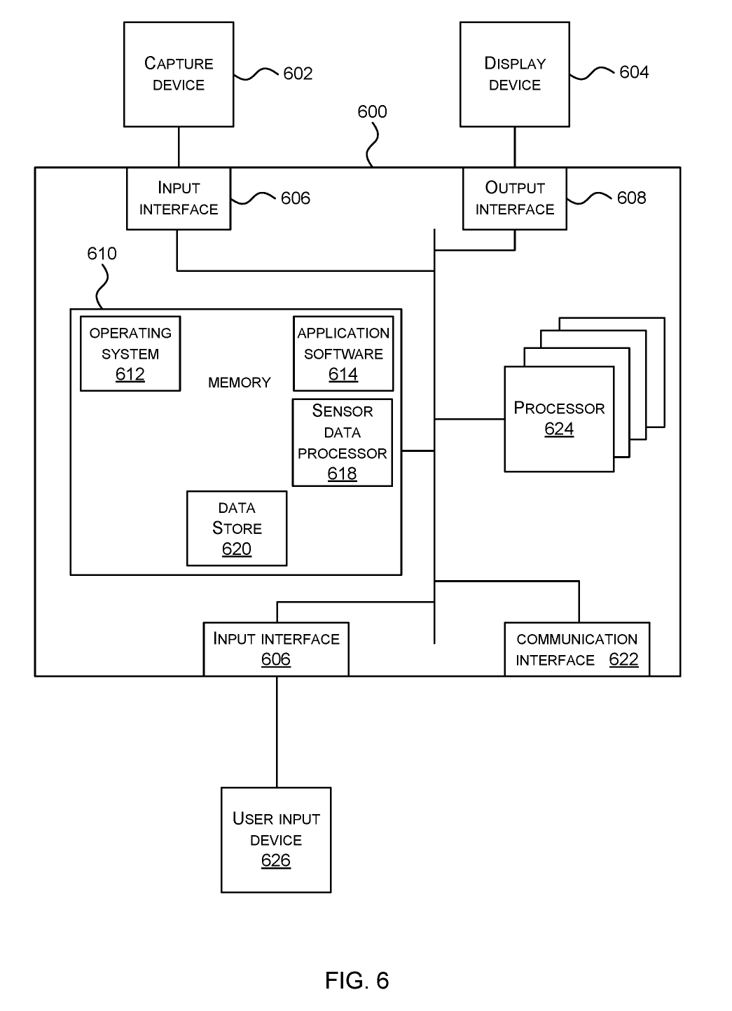

The trained expert models 116 are stored in a memory of the sensor data processor 114 (see FIG. 6 later) and the sensor data processor has a processor 118 in some examples. Feedback about predictions of the trained expert models is received by the sensor data processor 114 and used to update the way the trained expert models 116 are used to compute predictions. In this way performance is improved both for the current prediction and for future predictions. In some cases the update is carried out on the fly.

In the scenario of the game player 100 the feedback may comprise body joint position data from other sensors which are independent of the game apparatus, such as accelerometers on the user's clothing or body joint position data from other sources such as user feedback where the user speaks to indicate which pose he or she is in. In the scenario of the MRI scanner 120 the feedback may comprise annotations to slices of the MRI volume made by medical doctors using a graphical user interface. In some cases the feedback is automatically computed using other sources of information such as other medical data about the patient. In the scenario of the person 108 speaking into the smart phone 110 the feedback may comprise user manual touch input at the smart phone.

Alternatively, or in addition, the functionality of the sensor data processor is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

In some cases the sensor data processor is at an end user electronic device such as a personal desktop computer, a game apparatus (see 100 of FIG. 1), a smart phone 110, a tablet computer, a head worn augmented reality computing device, a smart watch or other end user electronic device. In some cases the sensor data processor is located in the cloud and accessible to end user electronic devices over the internet or other communications network. The functionality of the sensor data processor may be distributed between the end user electronic device and one or more other computing devices in some cases.

Where the sensor data processor 114 is in the cloud, the sensor data 112 is sent to the sensor data processor 114 over a communications network and feedback 124 is also sent to the sensor data processor 114. The sensor data processor computes predictions 122 and data about the predictions or derived using the predictions is sent back to the end user electronic device. The sensor data processor 114 uses the feedback 124 to compute updates to a predictor comprising the trained expert models 116 as explained in more detail below.

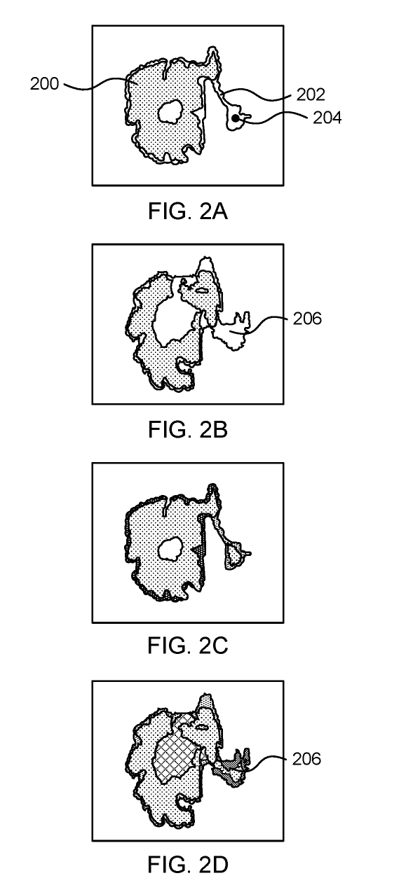

An example in which the sensor data processor 114 is a brain tumour segmentation system which is based on decision forests is described below and FIGS. 2A to 2D are schematic diagrams of slices of medical resonance imaging (MRI) volumes which have been segmented using the segmentation system. FIGS. 2A and 2B are for the situation before feedback has been used to compute a refined prediction. FIGS. 2C and 2d are for the situation after feedback has been used to compute a refined prediction. FIG. 2A shows an interesting example where a part 202 of the tumour exists as a narrowly connected branch to the main body of the tumour and is missed by the initial segmentation (as indicated by the white fill of this branching body in FIG. 2A). On providing very simple feedback in the form of a few dots (illustrated in FIG. 2A as black dot 204 which have been added to the image of the slice by a medical doctor to indicate that the part of the image with the black dot should be segmented as part of the tumour although it has not been) the segmentation system is able to find most of the branched tumour as indicated in FIG. 2C by the dotted fill in the branched tumour region. More interestingly, the segmentation system is able to accurately locate how the branched tumour rejoins the main body of the tumour at another location as indicated in FIGS. 2B and 2D. In FIG. 2D the branched region is not detected as part of the tumour and so has a white fill. In FIG. 2D the branched region 206 is detected as part of the tumour as indicated by the dotted fill.

The segmentation system computes the predictions that give the images 2C and 2D on the fly whilst the medical Doctor is viewing the MRI results. This enables the medical Doctor to provide the feedback and view the updated predictions whilst he or she is completing the task of making a medical assessment. The Doctor does not need to come back later after a lengthy offline training process. In addition, the feedback provided by the Doctor is used to update weights in the predictor which computes the segmentation and so future MRI volumes are segmented more accurately.

An example in which the sensor data processor 114 is a speech input system (for inputting text to a computing device) is now described, where the predictor comprises a plurality of neural networks. Each neural network has been trained to predict a next phrase in a sequence of context words which have already been spoken into the computing device by the user. One or more of the predicted next phrases are offered as candidates to the user so the user is able to select one of the candidates for input by speaking a command to select that phrase. If the offered candidate is not helpful the user has to speak the individual words to be entered and the sensor data processor detects the spoken words and uses this as feedback. The feedback is used to update weights used to combine predictions from the different neural networks as described in more detail below.

FIG. 3 is a schematic diagram of the sensor data processor 114 in more detail. It comprises a plurality of trained expert models indicated in FIG. 3 as predictor A, predictor B and predictor C which are all slightly different from one another. A trained expert model is a predictor which has been formed by updating parameters of the predictor in the light of labeled training data. The predictor is an expert in the sense that it is knowledgeable about the training data used to update its parameters and is able to generalize to some extent from those training examples to other examples which it has not seen before. Where a plurality of trained expert models are used together these may be referred to as an ensemble, or as a mixture of experts. This is useful where each trained expert model is slightly different from the other trained expert models as a result of the training process. This means that the ensemble or collection of trained expert models is better able to generalize than any individual one of the trained expert models on its own. This generalization ability is achieved since, for a given input, the predictions from each of the trained expert models varies and by forming an output prediction which aggregates the individual predictions of the trained expert models more accurate results are achieved.

For example, a set of training data is divided into subsets and each subset used to train a support vector machine, neural network or another type of predictor. In another example, the same training data is used to train a plurality of random decision forests and these forests are each slightly different from one another due to random selection of ranges of parameters to select between as part of the training process. Each of the plurality of trained expert models is the same type of predictor in many cases. For example, each trained expert model is a random decision tree, or each trained expert model is a neural network. In other cases the individual trained expert models are of different types. For example, predictor A is a random decision tree and predictor B is a neural network.

In some cases the plurality of trained expert models is referred to as an ensemble such as an ensemble of random decision trees which together form a decision forest. It is also possible to have an ensemble of neural networks or an ensemble of support vector machines, or an ensemble of another type of predictor.

Associated with each trained expert model is a weight 300, 302, 304. Each weight comprises one or more numerical values such as a mean and a variance. In some examples the weights are normalized such that they are numerical values between zero and 1. The weights may be initialized to the same default value but this is not essential; in some cases the weights are initialized to randomly selected values.

A sensor data example 112 is observed and received at the sensor data processor. For example, a depth camera at the game apparatus senses a depth image, or a medical imaging device captures a medical volume, or a microphone senses an audio signal and the resulting sensor data is input to the processor. The processor computes a prediction, one from each of the individual trained expert models. The predictions are aggregated by an aggregator 306 which computes a weighted aggregation of the predictions for example, using the weights 300, 302, 304. As a result, an output prediction 116 is computed and sent to an assessment component 118.

The assessment component 118 is part of the sensor data processor 114 and is configured to obtain feedback 124 about the prediction 116. For example, the feedback is a ground truth value for the corresponding sensor data 112 or element of the sensor data. In the case of an image, the feedback may comprise a plurality of ground truth image labels for image elements such as pixels or voxels. In the case of a predicted joint position the feedback may comprise a ground truth joint position or a vector indicating how the predicted joint position is to be moved to reach a corrected position for that joint. Other types of feedback are used depending on the particular application domain.

The feedback 124 is user feedback and/or feedback which has been automatically computed using other sources of information. In the case of user feedback the assessment component 118 is arranged to present information about the prediction 116 to the user and invite the user to correct the prediction. Where the prediction is an image (or is data which may be displayed as an image) the image is presented on a graphical user interface which depicts class labels of the image elements using colours or other marks. In the case of body joint positions the assessment component 118 may present a graphical depiction of a game player with the predicted body joint positions shown as marks or colors and where the user is able to give feedback by dragging and dropping the body joint positions to correct them. In the case of an audio signal the assessment component may present text representing predicted phonemes and prompting the user to type in any corrections to the phonemes.

In the case of automatically computed feedback the assessment component 308 receives other sources of data which are used to check the accuracy of the prediction 116. A non-exhaustive list of examples of other sources of data is: sensor data from sensors other than those used to produce sensor data 112, data derived from the sensor data 112 using other predictors which are independent of the plurality of trained expert models 116, and combinations of these.

Once the feedback 124 is received it is used to update the weights 300, 302, 304. In some cases, the processor is configured to represent aggregation of the trained expert models 116 using a probabilistic model and to update the weights using the probabilistic model in the light of the feedback 124. In various examples this is done using an online Bayesian update 310 process which gives a principled framework for computing the update. However, it is not essential to use a Bayesian update process. In some cases, the processor is configured to compute each weight 300, 302, 304 as a prior probability of the prediction being from a particular one of the trained expert models 116 times the likelihood of the feedback 124. In some examples the processor is configured such that the update comprises multiplying a current weight 300, 302, 304 with a likelihood of the feedback 124 and then normalizing the weight.

After the weights have been updated a second aggregated prediction is computed. That is, the predictions which have already been computed from each of the individual predictors are aggregated again using aggregator 306, but this time using the updated weights 300, 302, 304. In this way the prediction 122 is refined so that it takes into account the feedback 124. The refined prediction is referred to as a second aggregated prediction herein and it is efficiently computed using a weighted aggregation such as a weighted average or other weighted aggregation of the already available predictions from the individual trained expert models. In this way the second aggregated prediction becomes available in real time, so that a downstream process or end user which makes use of the second aggregated prediction is immediately able to reap the benefits of the feedback 124. In addition, new examples of sensor data 112 which are processed by the sensor data processor yield more accurate predictions 122 since the weights 300, 302, 304 have been updated. Those new examples of sensor data 112 give rise to predictions 122 and feedback 124 and the process of FIG. 3 repeats so that over time the weights 300, 302, 304 move away from their initial default values and become more useful.

In some examples a probabilistic model of the plurality of trained expert models is used by the sensor data processor. An example of a probabilistic model which may be used is now given.

Let H_{I}_{_{N}} denote an ensemble (mixture of experts) of N models, where I_{N} is the index set I_{N}={1, 2, . . . , N}. For ease of exposition, consider the task of classification, although this model is applicable to any other supervised machine learning task, such as regression. Each model H_{i∈I}_{_{N}} defines posterior probabilities for each x∈X (where X is the input space) belonging to each class c∈I_{C}, denoted by Hᵢ(c|x). The prediction of the entire ensemble under a prior Pₚᵣᵢₒᵣ=(p₁, . . . , p_{N}) over the members of the ensemble is defined as:

$${H}_{{I}_{N}} ( c \vert x ) = {\sum }_{i = 1}^{N} p i {H}_{i} ( c \vert x ) ∀ c ∈ {I}_{c} , ∀ x ∈ x \qquad ( 1 )$$

The above probabilistic model is viewed as follows—first sample a member of the ensemble according to the prior distribution Pₚᵣᵢₒᵣ=(p₁, . . . , p_{N}). Denote this choice by the latent random variable z (hence z∈I_{N}). Then generate class labels for each data point, independently, using the sampled member of the ensemble.

H_{I}_{_{N}}(z|x)=Pₚᵣᵢₒᵣ(z) (2)

H_{I}_{_{N}}(c|z,x)=H_{z}(c|z,x) (3)

This model is depicted by the graphical model in FIG. 3A. The dataset consists of M data points, and vᵢ denotes the prediction made by the ensemble for the ith data point xᵢ.

The overall prediction is obtained by summing out the latent variable. Eqn (5) shows that the prediction of the whole ensemble is essentially a weighted average of the predictions of the individual experts, where the weights come from the prior.

$$\begin{matrix}{H}_{{I}_{N}} ( c \vert x ) = {\sum }_{z} {H}_{{I}_{N}} ( z \vert x ) {H}_{{I}_{N}} ( c \vert z , x ) & ( 4 ) \\ {H}_{{I}_{N}} ( c \vert x ) = {\sum }_{z} {P}_{prior} ( z ) {H}_{z} ( c \vert x ) & ( 5 )\end{matrix}$$

In the case of decision forests for medical image segmentation, z denotes the choice of the tree from the forest, the data points with indices I_{M} denotes the set of all voxels in the medical image, and vᵢ denotes the prediction of the decision forest for the ith voxel.

An example of Bayesian conditioning on the probabilistic model defined above is now given.

Given test points {x₁, . . . , x_{M}}, and also feedback truth labels for the first F test points, prediction on the remaining M to F points follows according to the Bayesian framework as conditioning on the probabilistic model defined above. FIG. 3B shows the conditioned version of the probabilistic graphical model, where the first F observations are conditioned. The filled nodes denote conditioning.

$$\begin{matrix} {H}_{{I}_{N}} ( {v}_{i} \vert {v}_{{I}_{F}} , {x}_{{I}_{F}} , {x}_{i} ) = {\sum }_{z} {H}_{{I}_{N}} ( {v}_{i} , z \vert {v}_{{I}_{F}} , {x}_{{I}_{F}} , {x}_{i} ) & ( 6 ) \\ {H}_{{I}_{N}} ( {v}_{i} \vert {v}_{{I}_{F}} , {x}_{{I}_{F}} , {x}_{i} ) = {\sum }_{z} {H}_{{I}_{N}} ( z \vert {v}_{{I}_{F}} , {x}_{{I}_{F}} , {x}_{i} ) {H}_{{I}_{N}} ( {v}_{i} \vert z , {v}_{{I}_{F}} , {x}_{{I}_{F}} , {x}_{i} ) & ( 7 ) \\ {H}_{{I}_{N}} ( {v}_{i} \vert {v}_{{I}_{F}} , {x}_{{I}_{F}} , {x}_{i} ) = {\sum }_{z} {H}_{{I}_{N}} ( z \vert {v}_{{I}_{F}} , {x}_{{I}_{F}} ) {H}_{z} ( {v}_{i} \vert {x}_{i} ) & ( 8 )\end{matrix}$$

Applying Bayes' rule gives:

$$\begin{matrix}{H}_{{I}_{N}} ( z \vert {v}_{{I}_{F}} , {x}_{{I}_{F}} ) = \frac{{H}_{{I}_{N}} ( {v}_{{I}_{F}} , z \vert {x}_{{I}_{F}} )}{{\sum }_{z} {H}_{{I}_{N}} ( {v}_{{I}_{F}} , z \vert {x}_{{I}_{F}} )} & ( 9 ) \\ {H}_{{I}_{N}} ( z \vert {v}_{{I}_{F}} , {x}_{{I}_{F}} ) = \frac{{H}_{{I}_{N}} ( z \vert {x}_{{I}_{F}} ) {H}_{{I}_{N}} ( {v}_{{I}_{F}} \vert z , {x}_{{I}_{F}} )}{{\sum }_{z} {H}_{{I}_{N}} ( z \vert {x}_{{I}_{F}} ) {H}_{{I}_{N}} ( {v}_{{I}_{F}} \vert z , {x}_{{I}_{F}} )} & ( 10 ) \\ {H}_{{I}_{N}} ( z \vert {v}_{{I}_{F}} , {x}_{{I}_{F}} ) = \frac{{P}_{prior} ( z ) {Π}_{f} {H}_{z} ( {v}_{f} \vert {x}_{f} )}{{\sum }_{z} {P}_{prior} ( z ) {Π}_{f} {H}_{z} ( {v}_{f} \vert {x}_{f} )} & ( 11 )\end{matrix}$$

Substituting equation 11 in equation 8 gives

$${H}_{{I}_{N}} ( {v}_{i} \vert {v}_{{I}_{F}} , {x}_{{I}_{{F}_{i}}} , {x}_{i} ) = {\sum }_{z} ( \frac{1}{K} \underbrace{\underbrace{{P}_{prior} ( z )}_{prior} \underbrace{{\prod }_{f} {H}_{z} ( {v}_{f} \vert {x}_{f} )}_{likelihood}}_{posterior} ) {H}_{z} ( {v}_{i} \vert {x}_{i} ) \qquad ( 12 )$$

where K=Σ_{z}Pₚᵣᵢₒᵣ (z) Π_{f} H_{z} (v_{f}|x_{f}) is a normalizing constant. Eqn (12) is of similar form as of Eqn (5), where the overall prediction is the weighted average of the predictions of the individual experts. However, the weights instead of being equal to the prior, equal the prior times the likelihood of the feedback observations i.e. the posterior over z. Hence, conditioning on feedback translates to a Bayesian re-weighting.

Equation 12 is expressed in words as the probability computed from the ensemble of trained experts H_{I}_{_{N}} of the ith data point vᵢ of the prediction given the value v_{I}_{_{F}} that the feedback takes, the feedback point

$${x}_{{I}_{{F}_{i}}}$$

and the ith data point of the sensor data xᵢ, is equal to the sum of the posterior probabilities that each of the individual expert models predicted the ith data point, times the probability of the ith data point of the prediction given the ith data point of the sensor data.

No special training or any kind of retraining of the original ensemble model is required. Thus the refinement technique is augmentative to the original trained model which enables it to be used with existing technology.

In the examples where the conditioning is Bayesian, interactive feedback is supported with multiple rounds of refinement. In each round, the posterior weights of members of the ensemble are updated by multiplying the current posterior weights with the likelihoods of newly observed feedback and normalizing.

FIG. 3C is a flow diagram of a method at the sensor data processor comprising region growing. This method is optional and is used in situations where the second aggregated prediction is to be computed extremely efficiently and for situations where the prediction is in the form of an image (which is two dimensional or higher dimensional). Each prediction comprises a plurality of elements such as voxels or pixels. The second aggregated prediction is computed for some but not all elements of the predictions and this gives computational efficiency. In order to select which elements of the predictions to use when computing the second aggregated prediction a region growing process is used as now described with reference to FIG. 3C.

Feedback is received 310 comprising a location in the image (as the prediction is in the form of an image). For example, the feedback is in the form of brushstrokes made by a clinician or medical expert to indicate that all voxels contained in the stroke volume belong to a particular class. The feedback is used to update the weights as described with reference to FIG. 3 above. The second aggregated prediction is then computed for those voxels in the stroke volume and optionally in a region around the stroke volume. A decision 314 is made about whether to grow the region or not. For example, if the number of iterations of the method of FIG. 3C has reached a threshold then the region is not grown and the second aggregated prediction is output 316. In another case, if there was little change between the pixels in the grown region between the previous version of the prediction and the current version of the prediction, then the region is not grown further and the current version of the prediction is output 316. If the region is to be grown its size is increased 318 and the prediction is recomputed 312 in the region around the feedback location.

In the case of a random decision forest being the trained plurality of expert models, an initial segmentation from the original decision forest is computed. After obtaining feedback, a re-weighted forest is computed by updating the weights as described above and the re-weighted forest and is used for retesting.

The region growing process starts from retesting the feedback voxels, and keeps retesting voxels neighbouring to the previously retested voxels in a recursive manner. This has the effect of a retesting region which starts off as the set of feedback voxels and keeps growing outward. The region, unless halted, will eventually grow into the entire medical image volume. To avoid retesting all voxels the processor stops region growing at the voxels where the predictions of the re-weighted forest match the predictions of the original forest, the underlying assumption being that the original forest can continue to be relied upon beyond this boundary. The result is a localized retesting region around the feedback voxels, whose voxels have all been assigned a different class label by the re-weighted forest.

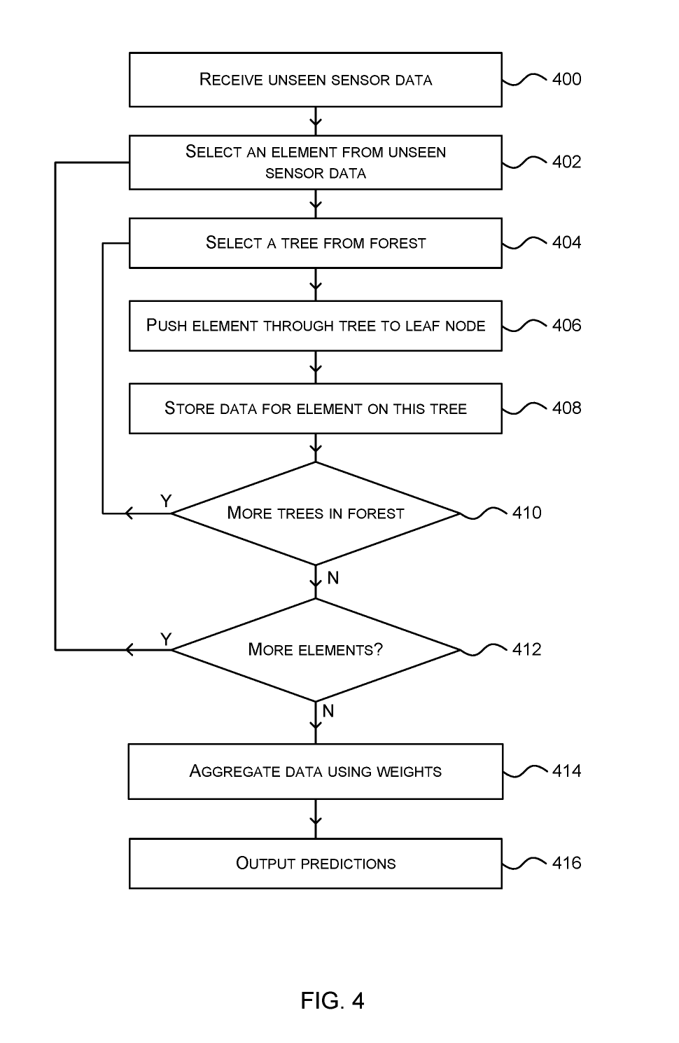

FIG. 4 is a flow diagram of a test time method, of using a trained random decision forest, which has been trained as described herein so that each tree of the forest has an associated weight, to compute a prediction. For example, to recognize a body organ in a medical image, to detect a gesture in a depth image or for other tasks.

Firstly, an unseen sensor data item such as an audio file, image, video or other sensor data item is received 400. Note that the unseen sensor data item can be pre-processed to an extent, for example, in the case of an image to identify foreground regions, which reduces the number of image elements to be processed by the decision forest. However, pre-processing to identify foreground regions is not essential.

A sensor data element is selected 402 such as an image element or element of an audio signal. A trained decision tree from the decision forest is also selected 404. The selected sensor data element is pushed 406 through the selected decision tree such that it is tested against the trained parameters at a split node, and then passed to the appropriate child in dependence on the outcome of the test, and the process repeated until the sensor data element reaches a leaf node. Once the sensor data element reaches a leaf node, the accumulated training examples associated with this leaf node (from the training process) are stored 408 for this sensor data element.

If it is determined 410 that there are more decision trees in the forest, then a new decision tree is selected 404, the sensor data element pushed 406 through the tree and the accumulated leaf node data stored 408. This is repeated until it has been performed for all the decision trees in the forest. Note that the process for pushing a sensor data element through the plurality of trees in the decision forest can also be performed in parallel, instead of in sequence as shown in FIG. 4.

It is then determined 412 whether further unanalyzed sensor data elements are present in the unseen sensor data item, and if so another sensor data element is selected and the process repeated. Once all the sensor data elements in the unseen sensor data item have been analyzed, then the leaf node data from the indexed leaf nodes is looked up and aggregated taking into account the weights of the individual decision trees 414 in order to compute one or more predictions relating to the sensor data item. The predictions 416 are output or stored.

The examples described herein use random decision trees and random decision forests. It is also possible to have some of the split nodes of the random decision trees merged to create directed acyclic graphs and form jungles of these directed acyclic graphs.

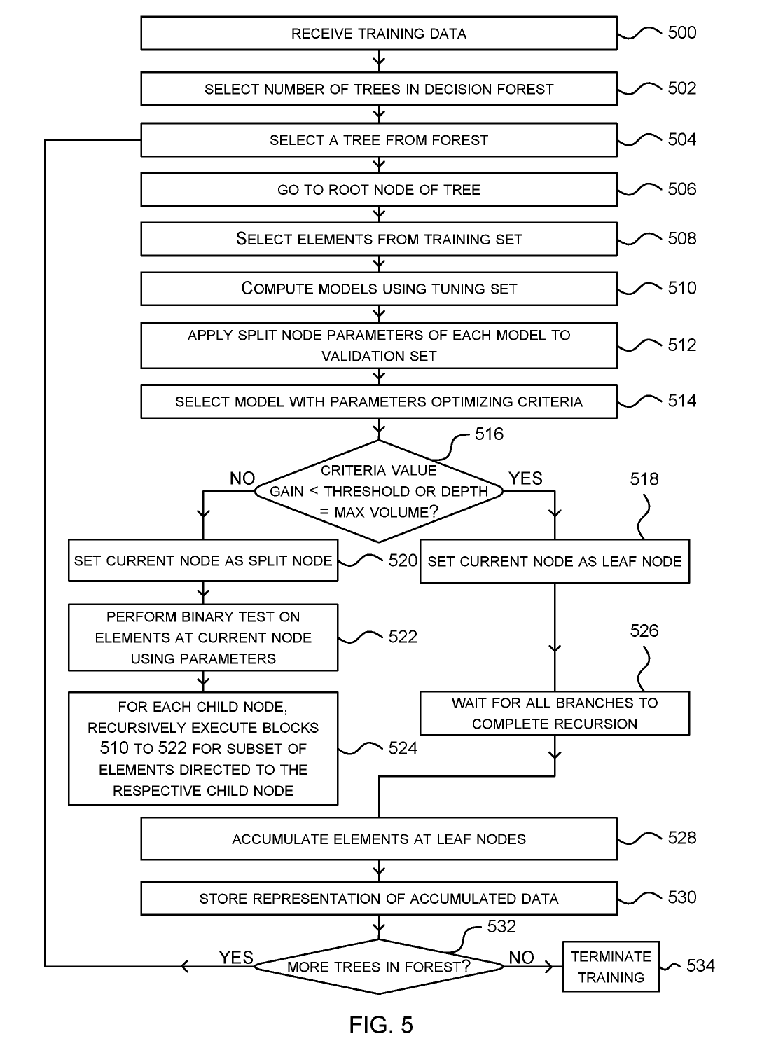

FIG. 5 is a flow diagram of a computer-implemented method of training a random decision forest. Note that this method does not include initializing the weights 300, 302, 304 associated with the individual trained expert models, and it does not include updating those weights in the light of feedback. These steps of initializing the weights and updating them are implemented as described earlier in this document. Training data is accessed 500 such as medical images which have labels indicating which body organs they depict, speech signals which have labels indicating which phonemes they encode, depth images which have labels indicating which gestures they depict, or other training data.

The number of decision trees to be used in a random decision forest is selected 502. A random decision forest is a collection of deterministic decision trees. Decision trees can be used in classification or regression algorithms, but can suffer from over-fitting, i.e. poor generalization. However, an ensemble of many randomly trained decision trees (a random forest) yields improved generalization. During the training process, the number of trees is fixed.

A decision tree from the decision forest is selected 504 and the root node is selected 506. A sensor data element is selected 508 from the training set.

A random set of split node parameters are then generated 510 for use by a binary test performed at the node. For example, in the case of images, the parameters may include types of features and values of distances. The features may be characteristics of image elements to be compared between a reference image element and probe image elements offset from the reference image element by the distances. The parameters may include values of thresholds used in the comparison process. In the case of audio signals the parameters may also include thresholds, features and distances.

Then, every combination of parameter value in the randomly generated set may be applied 512 to each sensor data element in the set of training data. For each combination, criteria (also referred to as objectives) are calculated 514. In an example, the calculated criteria comprise the information gain (also known as the relative entropy). The combination of parameters that optimize the criteria (such as maximizing the information gain) is selected 514 and stored at the current node for future use. As an alternative to information gain, other criteria can be used, such as Gini entropy, or the ‘two-ing’ criterion or others.

It is then determined 516 whether the value for the calculated criteria is less than (or greater than) a threshold. If the value for the calculated criteria is less than the threshold, then this indicates that further expansion of the tree does not provide significant benefit. This gives rise to asymmetrical trees which naturally stop growing when no further nodes are beneficial. In such cases, the current node is set 518 as a leaf node. Similarly, the current depth of the tree is determined (i.e. how many levels of nodes are between the root node and the current node). If this is greater than a predefined maximum value, then the current node is set 418 as a leaf node. Each leaf node has sensor data training examples which accumulate at that leaf node during the training process as described below.

It is also possible to use another stopping criterion in combination with those already mentioned. For example, to assess the number of example sensor data elements that reach the leaf. If there are too few examples (compared with a threshold for example) then the process may be arranged to stop to avoid overfitting. However, it is not essential to use this stopping criterion.

If the value for the calculated criteria is greater than or equal to the threshold, and the tree depth is less than the maximum value, then the current node is set 520 as a split node. As the current node is a split node, it has child nodes, and the process then moves to training these child nodes. Each child node is trained using a subset of the training sensor data elements at the current node. The subset of sensor data elements sent to a child node is determined using the parameters that optimized the criteria. These parameters are used in the binary test, and the binary test performed 522 on all sensor data elements at the current node. The sensor data elements that pass the binary test form a first subset sent to a first child node, and the sensor data elements that fail the binary test form a second subset sent to a second child node.

For each of the child nodes, the process as outlined in blocks 510 to 522 of FIG. 5 are recursively executed 524 for the subset of sensor data elements directed to the respective child node. In other words, for each child node, new random test parameters are generated 510, applied 512 to the respective subset of sensor data elements, parameters optimizing the criteria selected 514, and the type of node (split or leaf) determined 516. If it is a leaf node, then the current branch of recursion ceases. If it is a split node, binary tests are performed 522 to determine further subsets of sensor data elements and another branch of recursion starts. Therefore, this process recursively moves through the tree, training each node until leaf nodes are reached at each branch. As leaf nodes are reached, the process waits 526 until the nodes in all branches have been trained. Note that, in other examples, the same functionality can be attained using alternative techniques to recursion.

Once all the nodes in the tree have been trained to determine the parameters for the binary test optimizing the criteria at each split node, and leaf nodes have been selected to terminate each branch, then sensor data training examples may be accumulated 528 at the leaf nodes of the tree. This is the training level and so particular sensor data elements which reach a given leaf node have specified labels known from the ground truth training data. A representation of the accumulated labels may be stored 530 using various different methods. Optionally sampling may be used to select sensor data examples to be accumulated and stored in order to maintain a low memory footprint. For example, reservoir sampling may be used whereby a fixed maximum sized sample of sensor data examples is taken. Selection may be random or in any other manner.

Once the accumulated examples have been stored it is determined 532 whether more trees are present in the decision forest (in the case that a forest is being trained). If so, then the next tree in the decision forest is selected, and the process repeats. If all the trees in the forest have been trained, and no others remain, then the training process is complete and the process terminates 534.

Therefore, as a result of the training process, one or more decision trees are trained using training sensor data elements. Each tree comprises a plurality of split nodes storing optimized test parameters, and leaf nodes storing associated predictions. Due to the random generation of parameters from a limited subset used at each node, the trees of the forest are distinct (i.e. different) from each other.

FIG. 6 illustrates various components of an exemplary computing-based device 600 which are implemented as any form of a computing and/or electronic device, and in which embodiments of a sensor data processor 618 are implemented in some examples.

Computing-based device 600 comprises one or more processors 624 which are microprocessors, controllers or any other suitable type of processors for processing computer executable instructions to control the operation of the device in order to process sensor data to compute predictions using a plurality of trained expert models and update weights associated with those models in the light of feedback about the predictions. In some examples, for example where a system on a chip architecture is used, the processors 624 include one or more fixed function blocks (also referred to as accelerators) which implement a part of the method of any of FIGS. 3, 3C, 4, and 5 in hardware (rather than software or firmware). A sensor data processor 618 at the computing-based device is as described herein with reference to FIG. 1.

Platform software comprising an operating system 612 or any other suitable platform software is provided at the computing-based device to enable application software 614 to be executed on the device. For example, software for viewing medical images, game software, software for speech to text translation and other software.

The computer executable instructions are provided using any computer-readable media that is accessible by computing based device 600. Computer-readable media includes, for example, computer storage media such as memory 600 and communications media. A data store 620 at memory 610 is able to store predictions, sensor data, feedback and other data. Computer storage media, such as memory 610, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 610) is shown within the computing-based device 600 it will be appreciated that the storage is, in some examples, distributed or located remotely and accessed via a network or other communication link (e.g. using communication interface 622).

The computing-based device 600 also comprises an input interface 606 which receives input from a capture device 602 such as a camera or other sensor in order to obtain the sensor data for input to the sensor data processor 618. The input interface receives input from a user input device 626 in some examples, such as a mouse or keyboard used to add brushstrokes on an image. In some cases the user input device 626 is a touch screen or a microphone. Combinations of one or more different types of user input device 626 are used in some cases.

An output interface 608 is able to send predictions, feedback data or other output to a display device 604. For example, predicted images are displayed on the display device 604. The display device 604 may be separate from or integral to the computing-based device 600. In some examples the user input device 626 detects voice input, user gestures or other user actions and provides a natural user interface (NUI). This user input may be used to provide feedback about predictions. In an embodiment the display device 604 also acts as the user input device 626 if it is a touch sensitive display device. The output interface 608 outputs data to devices other than the display device 604 in some examples, e.g. a locally connected printing device (not shown in FIG. 6).

Any of the input interface 606, output interface 608, display device 604 and the user input device 626 may comprise technology which enables a user to interact with the computing-based device in a natural manner, free from artificial constraints imposed by input devices such as mice, keyboards, remote controls and the like. Examples of technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

Alternatively or in addition to the other examples described herein, examples include any combination of the following:

A sensor data processor comprising:

a memory storing a plurality of trained expert models;

a processor configured to

receive an unseen sensor data example and, for each trained expert model, compute a prediction from the unseen sensor data example using the trained expert model;

aggregate the predictions to form an aggregated prediction;

receive feedback about the aggregated prediction;

update, for each trained expert, a weight associated with that trained expert, using the received feedback;

compute a second aggregated prediction by computing an aggregation of the predictions which takes into account the weights.

In this way the sensor data processor is updated efficiently during use of the sensor data processor to compute predictions. The sensor data processor is able to recompute the current prediction taking into account the feedback and is also able to perform better when it computes predictions from new sensor data items.

The sensor data processor as described above wherein the processor is configured to carry out online update by receiving the feedback and computing the second aggregated prediction as part of operation of the sensor data processor to compute predictions from unseen sensor data. The online nature of the update is very beneficial to end users and downstream processes which make use of the predictions.

The sensor data processor as described above wherein the processor is configured to set initial values of the weights to the same value. This provides a simple and effective way of initializing the weights which is found to work well in practice.

The sensor data processor as described above wherein the processor is configured to represent aggregation of the trained expert models using a probabilistic model and to update the weights using the probabilistic model in the light of the feedback. By using a probabilistic model a systematic framework is obtained for computing the updates.

The sensor data processor as described above wherein the processor is configured to compute each weight as a prior probability of the prediction being from a particular one of the trained expert models times the likelihood of the feedback. This also gives a systematic framework for computing the updates.

The sensor data processor as described above wherein the processor is configured such that the update comprises multiplying a current weight with a likelihood of the feedback and then normalizing the weight. This is efficient to compute in real time.

The sensor data processor as described above wherein each of the predictions comprises a plurality of corresponding elements, and wherein the processor is configured such that computing the second aggregated prediction comprises computing an aggregation of initial ones of the elements of the predictions, taking into account the weights, wherein the initial ones are selected using the feedback and the initial ones are some but not all of the elements of the predictions. In this way computational efficiencies are made since some but not all of the elements are used and yet the results are still useful.

The sensor data processor as described above comprising increasing the number of elements of the predictions which are aggregated by including elements which are neighbors of the initial ones of the elements.

The sensor data processor as described above comprising iteratively increasing the number of elements and stopping the increase when no change is observed. This gives an effective way of gradually increasing the work involved so that unnecessary work is avoided and resources are conserved.

The sensor data processor as described above wherein the processor is configured to receive the feedback in the form of user input.

The sensor data processor as described above wherein the processor is configured to receive feedback in the form of user input relating to individual elements of the aggregated prediction.

The sensor data processor as described above wherein the processor is configured to receive the feedback from a computer-implemented process.

The sensor data processor as described above wherein the unseen sensor data example is an image.

The sensor data processor as described above wherein the unseen sensor data example is a medical image comprising a medical image volume and wherein the feedback about the aggregated prediction is related to a slice of the medical image volume and wherein the second aggregated prediction is a medical image volume. In this way, feedback about a particular slice of the volume is used to update the prediction in other slices of the volume.

A computer-implemented method of online update of a sensor data processor comprising a plurality of trained expert models, the method comprising:

receiving, at a processor, an unseen sensor data example;

for each trained expert model, computing a prediction from the unseen sensor data example using the trained expert model;

aggregating the predictions to form an aggregated prediction;

receiving feedback about the aggregated prediction;

updating, for each trained expert, a weight associated with that trained expert, using the received feedback;

computing a second aggregated prediction by computing an aggregation of the predictions which takes into account the weights for at least some elements of the predictions.

A method as described above comprising representing aggregation of the trained expert models using a probabilistic model and using the probabilistic model to update the weights in the light of the feedback.

A method as described above comprising updating the weights by multiplying a current weight with a likelihood of the feedback and then normalizing the weight.

A method as described above wherein each of the predictions comprises a plurality of corresponding elements, and wherein computing the second aggregated prediction comprises computing an aggregation of initial ones of the elements of the predictions, taking into account the weights, wherein the initial ones are selected using the feedback and the initial ones are some but not all of the elements of the predictions.

A method as described above comprising wherein the unseen sensor data example is a medical image comprising a medical image volume and wherein the feedback about the aggregated prediction is related to a slice of the medical image volume and wherein the second aggregated prediction is a medical image volume around.

An image processing system comprising:

a memory storing a plurality of trained expert models;

a processor configured to receive an image and, for each trained expert model, compute a prediction from the image using the trained expert model;

aggregate the predictions to form an aggregated prediction;

receive feedback about the aggregated prediction;

update, for each trained expert, a weight associated with that trained expert, using the received feedback;

compute a second aggregated prediction by computing an aggregation of the predictions which takes into account the weights.

A computer-implemented method of online update of an image processor comprising a plurality of trained expert models, the method comprising:

receiving, at a processor, an unseen image;

for each trained expert model, computing a prediction from the unseen image using the trained expert model;

aggregating the predictions to form an aggregated prediction;

receiving feedback about the aggregated prediction;

updating, for each trained expert, a weight associated with that trained expert, using the received feedback;

computing a second aggregated prediction by computing an aggregation of the predictions which takes into account the weights for at least some elements of the predictions.

An image processor comprising a plurality of trained expert models, the image processor comprising:

means for receiving, at a processor, an unseen image;

for each trained expert model, means for computing a prediction from the unseen image using the trained expert model;

means for aggregating the predictions to form an aggregated prediction;

means for receiving feedback about the aggregated prediction;

means for updating, for each trained expert, a weight associated with that trained expert, using the received feedback;

means for computing a second aggregated prediction by computing an aggregation of the predictions which takes into account the weights for at least some elements of the predictions.

For example, the means for receiving is processor 624, the means for computing is sensor data processor 618, the means for aggregating is aggregator 306, the means for receiving feedback is assessment component 308 and/or user input device 626 and input interface 606. For example, the means for updating is sensor data processor 618 and the means for computing is sensor data processor 618.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A sensor data processor comprising:
a memory storing a plurality of trained expert models;
a processor configured to
receive an unseen sensor data example and, for each trained expert model, compute a prediction from the unseen sensor data example using the trained expert model;
aggregate the predictions to form an aggregated prediction;
receive feedback about the aggregated prediction;
update, for each trained expert, a weight associated with that trained expert, using the received feedback;
compute a second aggregated prediction by computing an aggregation of the predictions which takes into account the weights.

2. The sensor data processor of claim 1 wherein the processor is configured to carry out online update of the machine learning system by receiving the feedback and computing the second aggregated prediction as part of operation of the machine learning system to compute predictions from unseen sensor data.

3. The sensor data processor of claim 1 wherein the processor is configured to set initial values of the weights to the same value.

4. The sensor data processor of claim 1 wherein the processor is configured to represent aggregation of the trained expert models using a probabilistic model and to update the weights using the probabilistic model in the light of the feedback.

5. The sensor data processor of claim 1 wherein the processor is configured to compute each weight as a prior probability of the prediction being from a particular one of the trained expert models times the likelihood of the feedback.

6. The sensor data processor of claim 1 wherein the processor is configured such that the update comprises multiplying a current weight with a likelihood of the feedback and then normalizing the weight.

7. The sensor data processor of claim 1 wherein each of the predictions comprises a plurality of corresponding elements, and wherein the processor is configured such that computing the second aggregated prediction comprises computing an aggregation of initial ones of the elements of the predictions, taking into account the weights, wherein the initial ones are selected using the feedback and the initial ones are some but not all of the elements of the predictions.

8. The sensor data processor of claim 7 comprising increasing the number of elements of the predictions which are aggregated by including elements which are neighbors of the initial ones of the elements.

9. The sensor data processor of claim 8 comprising iteratively increasing the number of elements and stopping the increase when no change is observed.

10. The sensor data processor of claim 1 wherein the processor is configured to receive the feedback in the form of user input.

11. The sensor data processor of claim 10 wherein the processor is configured to receive feedback in the form of user input relating to individual elements of the aggregated prediction.

12. The sensor data processor of claim 1 wherein the processor is configured to receive the feedback from a computer-implemented process.

13. The sensor data processor of claim 1 wherein the unseen sensor data example is an image.

14. The sensor data processor of claim 1 wherein the unseen sensor data example is a medical image comprising a medical image volume and wherein the feedback about the aggregated prediction is related to a slice of the medical image volume and wherein the second aggregated prediction is a medical image volume.

15. A computer-implemented method of online update of a trained machine learning system comprising a plurality of trained expert models, the method comprising:
receiving, at a processor, an unseen sensor data example;
for each trained expert model, computing a prediction from the unseen sensor data example using the trained expert model;
aggregating the predictions to form an aggregated prediction;
receiving feedback about the aggregated prediction;
updating, for each trained expert, a weight associated with that trained expert, using the received feedback;
computing a second aggregated prediction by computing an aggregation of the predictions which takes into account the weights for at least some elements of the predictions.

16. A method as claimed in claim 15 comprising representing aggregation of the trained expert models using a probabilistic model and using the probabilistic model to update the weights in the light of the feedback.

17. A method as claimed in claim 15 comprising updating the weights by multiplying a current weight with a likelihood of the feedback and then normalizing the weight.

18. A method as claimed in claim 15 wherein each of the predictions comprises a plurality of corresponding elements, and wherein computing the second aggregated prediction comprises computing an aggregation of initial ones of the elements of the predictions, taking into account the weights, wherein the initial ones are selected using the feedback and the initial ones are some but not all of the elements of the predictions.

19. A method as claimed in claim 15 comprising wherein the unseen sensor data example is a medical image comprising a medical image volume and wherein the feedback about the aggregated prediction is related to a slice of the medical image volume and wherein the second aggregated prediction is a medical image volume around.

20. An image processing system comprising:
a memory storing a plurality of trained expert models;
a processor configured to
receive an image and, for each trained expert model, compute a prediction from the image using the trained expert model;
aggregate the predictions to form an aggregated prediction;
receive feedback about the aggregated prediction;
update, for each trained expert, a weight associated with that trained expert, using the received feedback;
compute a second aggregated prediction by computing an aggregation of the predictions which takes into account the weights.
